(19) United States
(12) Patent Application Publication
(10) Pub. No.: US 2025/0271342 A1
(43) Pub. Date: Aug. 28, 2025

(54) Method and Apparatus for Indexing and Batching Shafts

(71) Applicants: Mason Springer, Rushville, OH (US); Garland Naistetler, Logan, OH (US)

(72) Inventors: Mason Springer, Rushville, OH (US); Garland Naistetler, Logan, OH (US)

(21) Appl. No.: 18/584,822

(22) Filed: Feb. 22, 2024

(51) Int. Cl. G01N 3/16; B07B 13/00

(52) U.S. Cl. CPC G01N 3/16; B07B 13/003; G01N 2203/0019

(57) ABSTRACT

A method and apparatus for indexing and batching shafts. In some embodiments the apparatus for indexing and batching shafts includes a body having upper and lower portions as well as inner and outer portions, a mechanism for applying force to a shaft longitudinally, and the apparatus is configured so the applied force causes the shaft to deflect along the first dynamic bend. The apparatus is configured to attach and detach a single or plurality of gauges.

### BACKGROUND

In real world products there is never perfection, some examples could be, multiple archery arrows that each deflect differently under the load of a bow assembly, a golf club shaft wherein the first dynamic bend is not oriented correctly for the swing of the golfer, or structural asymmetry in a shaft causing the existence of a first dynamic bend. However, there are apparatuses and methods to enhance the consistency of those shafts. Individuals typically want their shafts to have as little deviation between each shaft as possible, and to orient the structural asymmetries in the shaft. Most methods and apparatuses for making shafts more consistent are not to the very high standard of what most individuals desire.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

In general terms, this disclosure is directed to a method for indexing and batching shafts. In some embodiments the method for indexing and batching shafts includes inserting a shaft into an indexing and batching apparatus, operating the apparatus resulting in longitudinal force being applied to the shaft, observing and measuring the properties of the shaft under load, allowing the batching of shafts with similar or identical characteristics.

In general terms this disclosure is also directed to an apparatus for indexing and batching shafts. In some embodiments the apparatus for indexing and batching shafts includes a body having upper and lower portions as well as inner and outer portions, a mechanism for applying force to a shaft longitudinally, and the apparatus is configured so the applied force causes the shaft to deflect along the first dynamic bend.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front view with a break line of an apparatus for indexing and batching arrows according to an embodiment of the disclosure.

FIG. 2 is a side view of the lower portion of the apparatus depicting the lower internal and external mechanisms according to an embodiment of the disclosure.

FIG. 3 is a side view of the upper portion of the apparatus depicting the upper internal and external mechanisms according to an embodiment of the disclosure.

FIG. 4 is a bottom view of the upper portion of the apparatus depicting a different view of the upper internal and external mechanisms according to an embodiment of the disclosure.

FIG. 5 is a perspective view of the apparatus with a break, depicting the upper portion, lower portion, and hand crank according to an embodiment of the disclosure.

FIG. 6 is a perspective view of a force gauge that could be attached to the apparatus according to an embodiment of the disclosure.

FIG. 7 is a perspective view of an indexing bracket that could be fastened to the apparatus according to an embodiment of the disclosure.

FIG. 8 is a side view of the apparatus depicting the apparatus with a shaft and a shaft deflecting along the first dynamic bend according to an embodiment of the disclosure.

FIG. 9 is a cross section view of an embodiment of a shaft exaggerating the structural asymmetries in the shaft wall that may not be readily apparent in real world situations.

Each portion of the apparatus is labeled with numerals as follows, indexing and batching apparatus 001, force gauge 002, indexing bracket 003, shaft 004, shaft deflected along the first dynamic bend 005, pivot points 006 (A/B), crank handle (rotating) 007, mounting holes for extra appendages 008, threaded rod 009, receiving depressions (A/B) 010, mounting plate 011, low friction guide 012, body 013, threaded receiver 014, sliding block 015, rail system 016, shaft wall 017, guide for threaded rod (A/B) 018.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure generally provides a method and apparatus to make the properties of shafts more apparent.

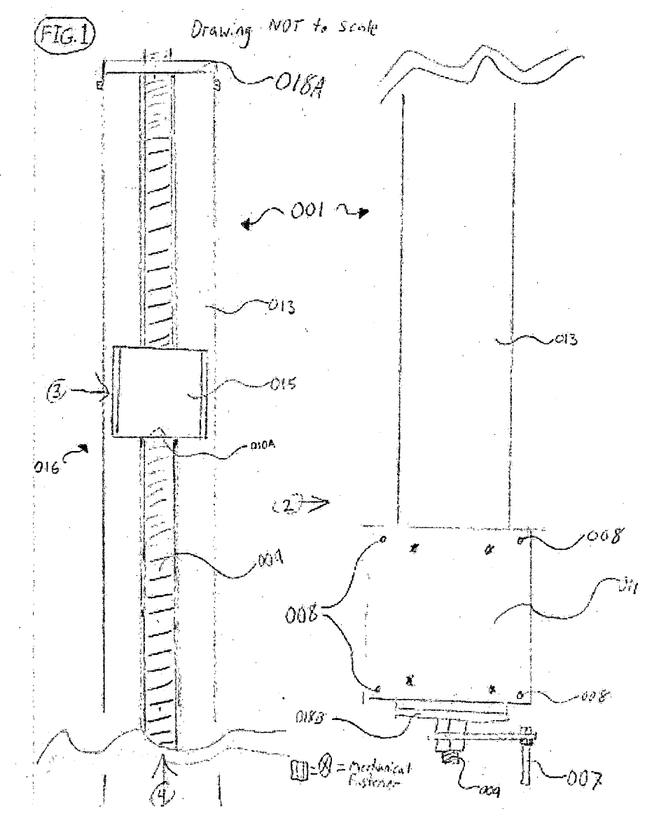

Referring to FIG. 1 an embodiment of an indexing and batching apparatus 001 without the optional appendages to receive the lower end of the shaft is depicted. Examples of shafts 004 may be archery arrow shafts, golf shafts, and spear shafts. FIG. 1 depicts an embodiment of the apparatus with a break line that separates the upper and lower portions of the apparatus.

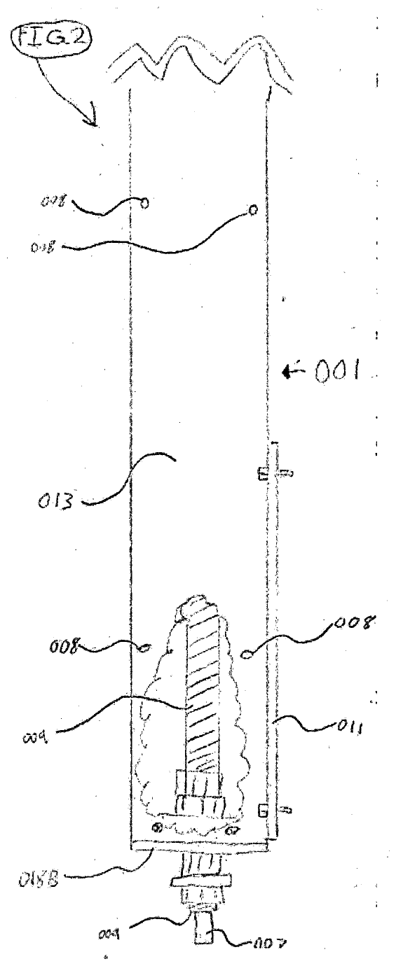

Referring to FIG. 1, an embodiment of the indexing and batching apparatus 001 is depicted with a body 013, hand crank 007, mounting plate 011, sliding block assembly 015, rail system 016, threaded rod 009, mounting holes 008 for extra appendages, upper receiving depression 010A, and mounting plate 011. The embodiment pictured depicts a body 013 with threaded rod 009 running through the length of the body 013 secured with mechanical fasteners at the lower end of the body 013 to the crank handle 007. The upper and lower ends of the threaded rod 009 are able to free spin within upper and lower guides for threaded rod 018. As depicted in the embodiment in FIG. 2, attached to the lower end of the threaded rod 009 is a crank handle 007 held in place on the threaded rod 009 by mechanical fasteners. The threaded rod is held in place, but not restricted from rotating, above and below the lower guide for threaded rod 018B by mechanical fasteners.

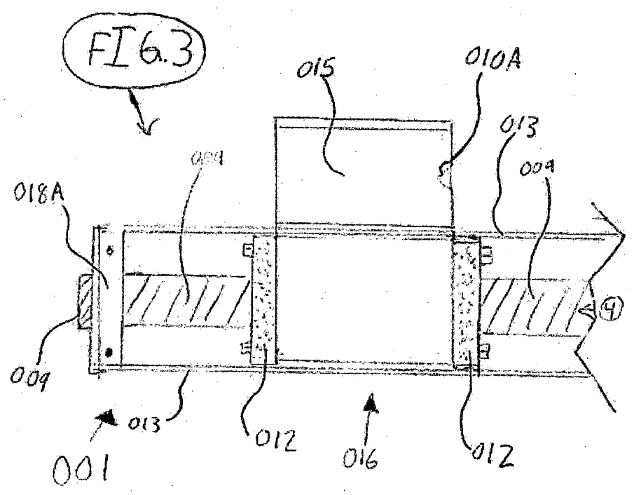

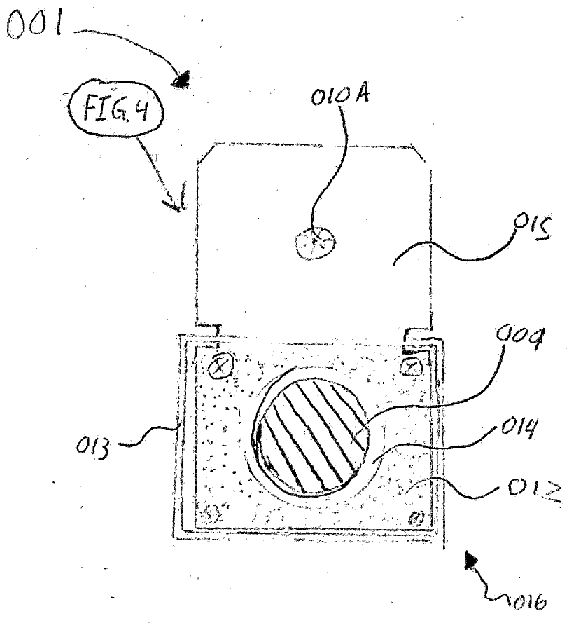

Referring to FIG. 1, an embodiment of an indexing and batching apparatus, is depicted with a break in the midsection to draw attention to the ends of the apparatus. The upper portion of the apparatus is depicted with a rail system 016, a sliding block 015, and threaded rod 009. As seen in FIG. 3 the body 013 acts as a rail to the sliding block 015 which is held on the rail by a low friction guide 012. As depicted in FIG. 4 the sliding block 015 may be held in place on the threaded rod 009 by a threaded receiver 014. As the crank handle 007 is rotated, the threaded rod 009 transfers torque to the threaded receiver 014 which in turn moves the sliding block 015 along the rail system 016.

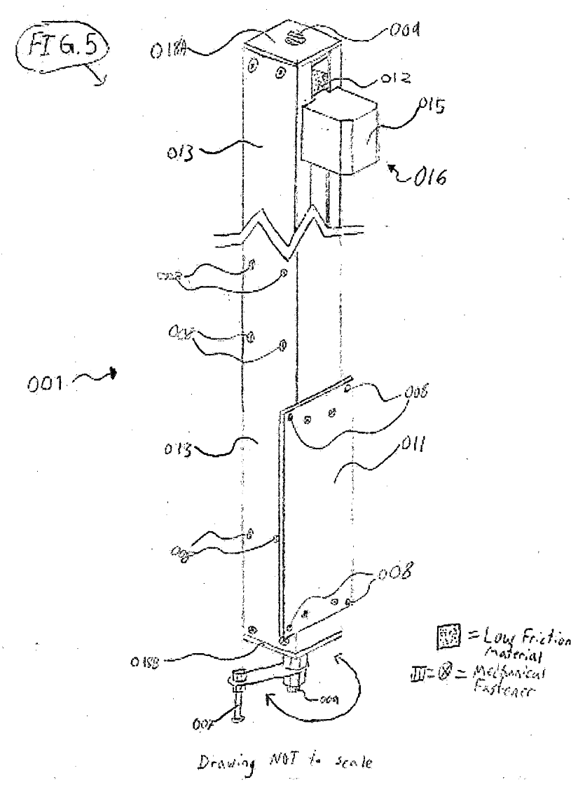

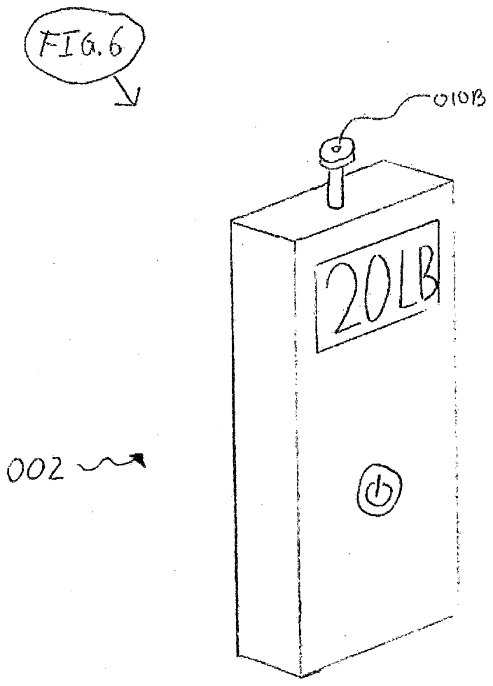

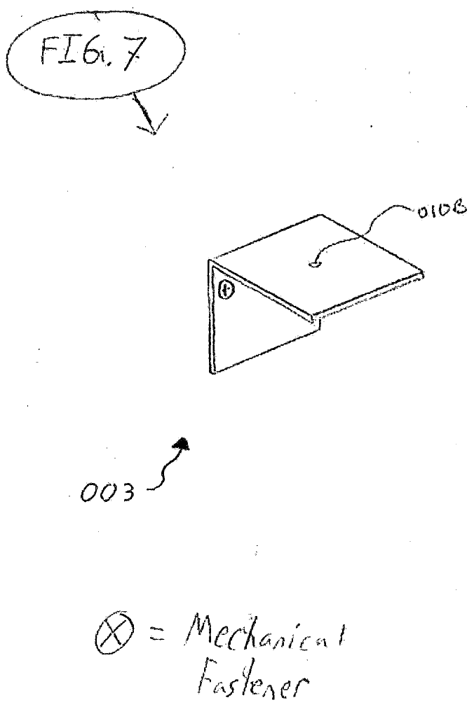

Referring to FIG. 5 and embodiment of an indexing and batching apparatus 001 is depicted with a mounting plate 011 for attaching optional appendages. These appendages may include a gauge 002 (depicted in FIG. 6) or an indexing bracket 003 (depicted in FIG. 7). Any commercially available force gauge may be fitted on the mounting plate 011 provided it has the correct mounting structures. Each appendage attached to the mounting plate is configured to receive the lower pivot point 006B with a receiving depression 010B.

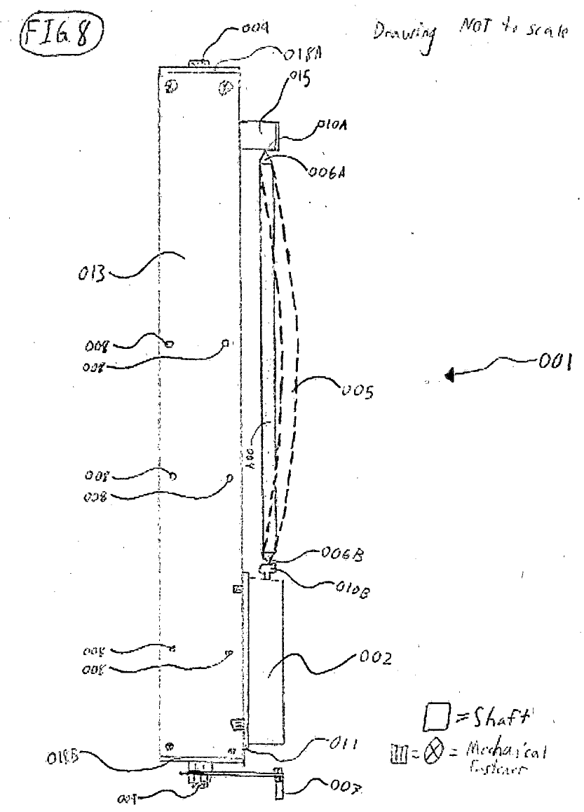

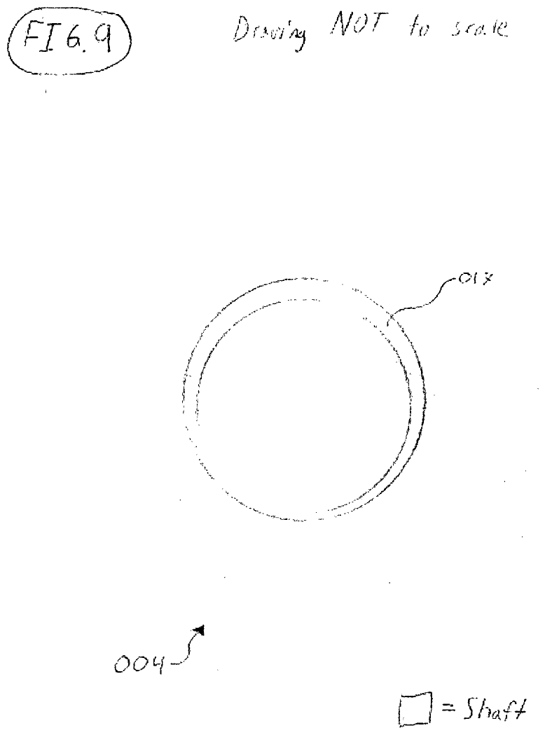

Referring to FIG. 8 an embodiment of an indexing and batching apparatus 001 is depicted with a force gauge 002 and a shaft 004 in the vertical position. The shaft 004 is held in place by two pivot points. 006 on both ends of the shaft and are received by receiving depressions 010. An individual rotates the crank handle 007 that then moves the sliding block 015 along the rail system 016 which applies force to the shaft 004 longitudinally. When the shaft is positioned vertically in space, there is virtually no gravity effect on the deflection of the shaft. When force is applied to the shaft longitudinally, the shaft deflects along the first dynamic bend (as depicted in FIG. 8). The first dynamic bend of a shaft is a result of real-world structural asymmetries (as depicted in FIG. 9) that cause a shaft to deflect a certain direction based on the location of these asymmetries. The individual then observes the location of the first dynamic bend. Applying increasing amounts of force to the shaft 004 causes it to deflect (refer to 005) and there the individual is able to measure the longitudinal force it takes to deflect the shaft 004 a measurable amount which correlates to the resonance frequency of the shaft and the elasticity of the shaft. Once the first dynamic bend and other properties are determined, the individual can then index and batch shafts 004 to those properties.

What is claimed is:

1. A method for indexing and batching shafts, comprising;
inserting a shaft into an indexing and batching apparatus;
operating the apparatus resulting in longitudinal force being applied to the shaft;
observing and measuring the properties of the shaft under load;
batching each shaft based on its specific properties.

2. The method of claim 1, wherein the body and shaft may be positioned vertically.

3. The method of claim 1, wherein the shaft is flexed on a plurality of concentric pivot points.

4. The method of claim 1, wherein the shaft is flexing along the first dynamic bend.

5. The method of claim 4, wherein these properties are observed and measured;
the location of the first dynamic bend on the shaft
the amount of deflection of a shaft while flexing along the first dynamic bend, under load;
the amount of force applied to the shaft to result in a measurable deflection;

6. An apparatus for indexing and batching shafts comprising;
a body having upper and lower portions as well as inner and outer portions;
a mechanism for applying force to a shaft longitudinally, but not limited to;
the applied force causes the shaft to deflect along the first dynamic bend.

7. The apparatus of claim 6, wherein the body of the apparatus is sized to accommodate the deflection of the shaft.

8. The apparatus of claim 6, wherein the mechanism is applying force to locate to first dynamic bend.

9. The apparatus of claim 6, wherein the body is sized to accommodate varying sizes of shafts.

10. The apparatus of claim 6, wherein the indexing and batching apparatus may be configured to be operated manually.

11. The apparatus of claim 6, wherein the indexing and batching apparatus may be configured to receive optional appendages.

12. The apparatus of claim 6, wherein the indexing and batching apparatus may contain a threaded system that allows a sliding block assembly to apply force to a shaft.

13. The apparatus of claim 12, wherein the apparatus contains a hand crank that rotates and mechanically fastens a threaded rod that then moves the sliding block assembly to apply force to a shaft.

14. The apparatus of claim 12, wherein the sliding block assembly is encased in a rail system.

15. The apparatus of claim 12, wherein the sliding block assembly attaches to and is moved by the threaded rod along a rail system on and/or in the body of the apparatus;
the sliding block comprising;
a portion that attaches the block to the threaded rod;
a low friction material that contacts the rail system; and
a receiver for an end of a shaft

16. The apparatus of claim 12, wherein attached to the body is a mounting plate for optional appendages, such as but not limited to, a gauge.
